(19) United States
(12) Patent Application Publication
(10) Pub. No.: US 2026/0025283 A1
(43) Pub. Date: Jan. 22, 2026

(54) METHOD AND APPARATUS RELATED TO DIGITAL CERTIFICATE CERTIFYING CRYPTOGRAPHIC KEY FOR AN ENTITY IMPLEMENTING ONE OR MORE NETWORK FUNCTIONS OF A CORE NETWORK FOR A MOBILE COMMUNICATION SYSTEM

(71) Applicant: Nokia Technologies Oy, Espoo (FI)

(72) Inventors: Sireesha BOMMISETTY, Bangalore (IN); German PEINADO GOMEZ, Wroclaw (PL); Saurabh KHARE, Bangalore (IN); Mallikarjunudu MAKHAM, Bangalore (IN); Topuri BRAHMAIAH, Bangalore (IN)

(21) Appl. No.: 18/997,423

(22) PCT Filed: Aug. 8, 2023
(86) PCT No.: PCT/EP2023/071879

§ 371 Date: Jan. 21, 2025

(30) Foreign Application Priority Data
Oct. 3, 2022 (IN) 202241056765

(51) Int. Cl. H04L 9/32; H04L 9/00

(52) U.S. Cl. CPC H04L 9/3268; H04L 9/006; H04L 9/3213

(57) ABSTRACT

There are provided method, comprising: receiving, at a first entity implementing at least a first network function of a core network for a mobile communication system, a digital certificate certifying a cryptographic key for the first entity; wherein the digital certificate indicates one or more purposes for which the digital certificate certifies the cryptographic key; and sending the digital certificate from the first entity to a second entity implementing at least a second network function of the core network for the mobile communication system.

### TECHNICAL FIELD

Example embodiments relate to apparatus, a method, and a computer program, and in particular, but not exclusively to apparatus, methods and computer programs related to a digital certificate certifying a cryptographic key for an entity implementing one or more functions of a core network for a mobile communication system.

### BACKGROUND

A core network for a mobile communication system may adopt a service-based architecture (SBA) according to which communication between network functions uses Service Based Interfaces (SBIs). Interactions between entities implementing network functions of the core network may use cryptographic keys.

### SUMMARY

A method, comprising: receiving, at a first entity implementing at least a first network function of a core network for a mobile communication system, a digital certificate certifying a cryptographic key for the first entity; wherein the digital certificate indicates one or more purposes for which the digital certificate certifies the cryptographic key; and sending the digital certificate from the first entity to a second entity implementing at least a second network function of the core network for the mobile communication system.

The one or more purposes may comprise one or more of: establishing a secure logical connection between the first and second entities; or verifying client credential assertion tokens; or verifying access tokens; or verifying service request.

The digital certificate may conform to ITU-T X.509 standard for public key infrastructures.

The digital certificate may include a field populated by one or more identifier values indicating the one or more purposes.

The digital certificate may include a field supporting free text, and the field includes free text indicating the one or more purposes.

The field supporting free text may also indicate a subject name.

Sending the digital certificate from the first entity to the second entity may be at least for establishing a secure connection between the first and second entities using at least the cryptographic key of the first entity; and the one or more purposes may comprise establishing a secure connection between first and second entities.

The method may further comprise: requesting via the secure logical connection between the first and second entities a service exposed by the second entity.

Requesting the service may comprise sending a digital signature for a token to access the service, wherein the digital signature is verifiable at the second entity using the cryptographic key of the first entity.

The method may comprise: requesting the digital certificate from a certificate authority.

A method, comprising: receiving, from a first entity implementing at least a first network function of a core network for a mobile communication system at a second entity implementing at least a second network function of the core network for the mobile communication system, a digital certificate including an indication of one or more purposes for which the digital certificate certifies a cryptographic key for the first entity; and based at least partly on the indication of the one or more purposes, determining at the second entity whether to proceed with one or more operations involving the cryptographic key of the first entity.

The method may further comprise: based at least partly on the indication of the one or more purposes, determining whether to establish a secure logical connection between the first and second entities using at least the cryptographic key of the first entity.

The method may comprise: receiving from the first entity a service request including a digital signature for a service access token, and based at least partly on the indication of the one or more purposes, determining whether the cryptographic key is certified for verifying the digital signature.

The method may comprise: based at least partly on the indication of the one or more purposes, determining whether to request the first entity to request an access token on behalf of the second entity.

A method comprising: receiving a request to generate a digital certificate certifying a cryptographic key for a first entity implementing one or more network functions of a core network of a mobile communication system; wherein the request indicates one or more purposes for which the digital certificate certifies the cryptographic key; and issuing a digital certificate including an indication of the one or more purposes.

The method may comprise sending the digital certificate to the first entity or an entity implementing operations, administration and maintenance functions for the core network of the mobile communication system.

A method comprising: sending a request to generate a digital certificate certifying a cryptographic key for a first entity implementing one or more network functions of a core network of a mobile communication system; wherein the request indicates one or more purposes for which the digital certificate certifies the cryptographic key; and receiving a digital certificate including an indication of the one or more purposes.

The sending and receiving may be performed at an entity implementing operations, administration and maintenance functions for the core network, and the method may further comprise sending the digital certificate to the first entity from the entity implementing operations, administration and maintenance functions for the core network.

A first entity implementing at least a first network function of a core network for a mobile communication system, the first entity comprising: means for receiving a digital certificate certifying a cryptographic key for the first entity; wherein the digital certificate indicates one or more purposes for which the digital certificate certifies the cryptographic key; and means for sending the digital certificate to a second entity implementing at least a second network function of the core network for the mobile communication system.

The one or more purposes may comprise one or more of: establishing a secure logical connection between the first and second entities; or verifying client credential assertion tokens; or verifying access tokens; or verifying service request.

The digital certificate may conform to ITU-T X.509 standard for public key infrastructures.

The digital certificate may include a field populated by one or more identifier values indicating the one or more purposes.

The digital certificate may include a field supporting free text, and the field includes free text indicating the one or more purposes.

The field supporting free text may also indicates a subject name.

Sending the digital certificate from the first entity to the second entity may be at least for establishing a secure connection between the first and second entities using at least the cryptographic key of the first entity; and wherein the one or more purposes comprise establishing a secure connection between first and second entities.

The first entity may further comprise: means for requesting via the secure logical connection between the first and second entities a service exposed by the second entity.

Requesting the service may comprise sending a digital signature for a token to access the service, wherein the digital signature is verifiable at the second entity using the cryptographic key of the first entity.

The first entity may comprise: means for requesting the digital certificate from a certificate authority.

A second entity implementing at least a second network function of a core network for a mobile communication system, the second entity comprising: means for receiving, from a first entity implementing at least a first network function of the core network for the mobile communication system, a digital certificate including an indication of one or more purposes for which the digital certificate certifies a cryptographic key for the first entity; and means for, based at least partly on the indication of the one or more purposes, determining whether to proceed with one or more operations involving the cryptographic key of the first entity.

The second entity may further comprise: means for, based at least partly on the indication of the one or more purposes, determining whether to establish a secure logical connection between the first and second entities using at least the cryptographic key of the first entity.

The second entity may further comprise: means for receiving from the first entity a service request including a digital signature for a service access token, and means for, based at least partly on the indication of the one or more purposes, determining whether the cryptographic key is certified for verifying the digital signature.

The second entity may comprise: means for, based at least partly on the indication of the one or more purposes, determining whether to request the first entity to request an access token on behalf of the second entity.

Apparatus comprising: means for receiving a request to generate a digital certificate certifying a cryptographic key for a first entity implementing one or more network functions of a core network of a mobile communication system; wherein the request indicates one or more purposes for which the digital certificate certifies the cryptographic key; and means for issuing a digital certificate including an indication of the one or more purposes.

The apparatus may comprise means for sending the digital certificate to the first entity or an entity implementing operations, administration and maintenance functions for the core network of the mobile communication system.

Apparatus comprising: means for sending a request to generate a digital certificate certifying a cryptographic key for a first entity implementing one or more network functions of a core network of a mobile communication system; wherein the request indicates one or more purposes for which the digital certificate certifies the cryptographic key; and means for receiving a digital certificate including an indication of the one or more purposes.

The apparatus may comprise an entity implementing operations, administration and maintenance functions for the core network, and the apparatus may further comprise means for sending the digital certificate to the first entity.

A first entity implementing at least a first network function of a core network for a mobile communication system, the first entity comprising: at least one processor; and at least one memory including computer program code, the at least one memory and computer program code configured to, with the at least one processor, cause the first entity to perform: receiving a digital certificate certifying a cryptographic key for the first entity; wherein the digital certificate indicates one or more purposes for which the digital certificate certifies the cryptographic key; and sending the digital certificate to a second entity implementing at least a second network function of the core network for the mobile communication system.

The one or more purposes may comprise one or more of: establishing a secure logical connection between the first and second entities; or verifying client credential assertion tokens; or verifying access tokens; or verifying service request.

The digital certificate may conform to ITU-T X.509 standard for public key infrastructures.

The digital certificate may include a field populated by one or more identifier values indicating the one or more purposes.

The digital certificate may include a field supporting free text, and the field may include free text indicating the one or more purposes.

The field supporting free text may also indicate a subject name.

Sending the digital certificate from the first entity to the second entity may be at least for establishing a secure connection between the first and second entities using at least the cryptographic key of the first entity; and wherein the one or more purposes may comprise establishing a secure connection between first and second entities.

The at least one memory and computer program code may be further configured to, with the at least one processor, cause the first entity to request via the secure logical connection between the first and second entities a service exposed by the second entity.

Requesting the service may comprise sending a digital signature for a token to access the service, wherein the digital signature is verifiable at the second entity using the cryptographic key of the first entity.

The at least one memory and computer program code may be further configured to, with the at least one processor, cause the first entity to request the digital certificate from a certificate authority.

A second entity implementing at least a second network function of a core network for a mobile communication system, the second entity comprising: at least one processor; and at least one memory including computer program code, the at least one memory and computer program code configured to, with the at least one processor, cause the second entity to perform: receiving, from a first entity implementing at least a first network function of the core network for the mobile communication system, a digital certificate including an indication of one or more purposes for which the digital certificate certifies a cryptographic key for the first entity; and based at least partly on the indication of the one or more purposes, determining at the second entity whether to proceed with one or more operations involving the cryptographic key of the first entity.

The at least one memory and computer program code may be further configured to, with the at least one processor, cause the second entity to: based at least partly on the indication of the one or more purposes, determine whether to establish a secure logical connection between the first and second entities using at least the cryptographic key of the first entity.

The at least one memory and computer program code may be configured to, with the at least one processor, cause the second entity to: receive from the first entity a service request including a digital signature for a service access token, and based at least partly on the indication of the one or more purposes, determine whether the cryptographic key is certified for verifying the digital signature.

The at least one memory and computer program code may be configured to, with the at least one processor, cause the second entity to: based at least partly on the indication of the one or more purposes, determine whether to request the first entity to request an access token on behalf of the second entity.

Apparatus comprising: at least one processor; and at least one memory including computer program code, the at least one memory and computer program code configured to, with the at least one processor, cause the apparatus to perform: receiving a request to generate a digital certificate certifying a cryptographic key for a first entity implementing one or more network functions of a core network of a mobile communication system; wherein the request indicates one or more purposes for which the digital certificate certifies the cryptographic key; and issuing a digital certificate including an indication of the one or more purposes.

The at least one memory and computer program code may be configured to, with the at least one processor, cause the apparatus to: send the digital certificate to the first entity or an entity implementing operations, administration and maintenance functions for the core network of the mobile communication system.

Apparatus comprising: at least one processor; and at least one memory including computer program code, the at least one memory and computer program code configured to, with the at least one processor, cause the apparatus to perform: sending a request to generate a digital certificate certifying a cryptographic key for a first entity implementing one or more network functions of a core network of a mobile communication system; wherein the request indicates one or more purposes for which the digital certificate certifies the cryptographic key; and receiving a digital certificate including an indication of the one or more purposes.

The apparatus may be an entity implementing operations, administration and maintenance functions for the core network, and the at least one memory and computer program code may be configured to, with the at least one processor, cause the apparatus to send the digital certificate to the first entity.

A first entity implementing at least a first network function of a core network for a mobile communication system, comprising: receiving circuitry for receiving a digital certificate certifying a cryptographic key for the first entity; wherein the digital certificate indicates one or more purposes for which the digital certificate certifies the cryptographic key; and sending circuitry for sending the digital certificate to a second entity implementing at least a second network function of the core network for the mobile communication system.

A second entity implementing at least a second network function of the core network for the mobile communication system, comprising: receiving circuitry for receiving, from a first entity implementing at least a first network function of the core network for the mobile communication system, a digital certificate including an indication of one or more purposes for which the digital certificate certifies a cryptographic key for the first entity; and determining circuitry for, based at least partly on the indication of the one or more purposes, determining whether to proceed with one or more operations involving the cryptographic key of the first entity.

Apparatus comprising: receiving circuitry for receiving a request to generate a digital certificate certifying a cryptographic key for a first entity implementing one or more network functions of a core network of a mobile communication system; wherein the request indicates one or more purposes for which the digital certificate certifies the cryptographic key; and issuing a digital certificate including an indication of the one or more purposes.

Apparatus comprising: sending circuitry for sending a request to generate a digital certificate certifying a cryptographic key for a first entity implementing one or more network functions of a core network of a mobile communication system; wherein the request indicates one or more purposes for which the digital certificate certifies the cryptographic key; and receiving circuitry for receiving a digital certificate including an indication of the one or more purposes.

A computer readable medium comprising program instructions stored thereon for performing: receiving, at a first entity implementing at least a first network function of a core network for a mobile communication system, a digital certificate certifying a cryptographic key for the first entity; wherein the digital certificate indicates one or more purposes for which the digital certificate certifies the cryptographic key; and sending the digital certificate from the first entity to a second entity implementing at least a second network function of the core network for the mobile communication system.

A computer readable medium comprising program instructions stored thereon for performing: receiving, from a first entity implementing at least a first network function of a core network for a mobile communication system at a second entity implementing at least a second network function of the core network for the mobile communication system, a digital certificate including an indication of one or more purposes for which the digital certificate certifies a cryptographic key for the first entity; and based at least partly on the indication of the one or more purposes, determining at the second entity whether to proceed with one or more operations involving the cryptographic key of the first entity.

A computer readable medium comprising program instructions stored thereon for performing: receiving a request to generate a digital certificate certifying a cryptographic key for a first entity implementing one or more network functions of a core network of a mobile communication system; wherein the request indicates one or more purposes for which the digital certificate certifies the cryptographic key; and issuing a digital certificate including an indication of the one or more purposes.

A computer readable medium comprising program instructions stored thereon for performing: sending a request to generate a digital certificate certifying a cryptographic key for a first entity implementing one or more network functions of a core network of a mobile communication system; wherein the request indicates one or more purposes for which the digital certificate certifies the cryptographic key; and receiving a digital certificate including an indication of the one or more purposes.

A non-transitory computer readable medium comprising program instructions stored thereon for performing: receiving, at a first entity implementing at least a first network function of a core network for a mobile communication system, a digital certificate certifying a cryptographic key for the first entity; wherein the digital certificate indicates one or more purposes for which the digital certificate certifies the cryptographic key; and sending the digital certificate from the first entity to a second entity implementing at least a second network function of the core network for the mobile communication system.

A non-transitory computer readable medium comprising program instructions stored thereon for performing: receiving, from a first entity implementing at least a first network function of a core network for a mobile communication system at a second entity implementing at least a second network function of the core network for the mobile communication system, a digital certificate including an indication of one or more purposes for which the digital certificate certifies a cryptographic key for the first entity; and based at least partly on the indication of the one or more purposes, determining at the second entity whether to proceed with one or more operations involving the cryptographic key of the first entity.

A non-transitory computer readable medium comprising program instructions stored thereon for performing: receiving a request to generate a digital certificate certifying a cryptographic key for a first entity implementing one or more network functions of a core network of a mobile communication system; wherein the request indicates one or more purposes for which the digital certificate certifies the cryptographic key; and issuing a digital certificate including an indication of the one or more purposes.

A non-transitory computer readable medium comprising program instructions stored thereon for performing: sending a request to generate a digital certificate certifying a cryptographic key for a first entity implementing one or more network functions of a core network of a mobile communication system; wherein the request indicates one or more purposes for which the digital certificate certifies the cryptographic key; and receiving a digital certificate including an indication of the one or more purposes.

A computer program comprising computer executable code which when run on at least one processor is configured to cause a first entity implementing at least a first network function of a core network for a mobile communication system at least to: receive a digital certificate certifying a cryptographic key for the first entity; wherein the digital certificate indicates one or more purposes for which the digital certificate certifies the cryptographic key; and send the digital certificate to a second entity implementing at least a second network function of the core network for the mobile communication system.

A computer program comprising computer executable code which when run on at least one processor is configured to cause a second entity implementing at least a second network function of the core network for the mobile communication system at least to: receive, from a first entity implementing at least a first network function of the core network for the mobile communication system, a digital certificate including an indication of one or more purposes for which the digital certificate certifies a cryptographic key for the first entity; and based at least partly on the indication of the one or more purposes, determine at the second entity whether to proceed with one or more operations involving the cryptographic key of the first entity.

A computer program comprising computer executable code which when run on at least one processor is configured to cause an apparatus at least to: receive a request to generate a digital certificate certifying a cryptographic key for a first entity implementing one or more network functions of a core network of a mobile communication system; wherein the request indicates one or more purposes for which the digital certificate certifies the cryptographic key; and issue a digital certificate including an indication of the one or more purposes.

A computer program comprising computer executable code which when run on at least one processor is configured to cause an apparatus at least to: send a request to generate a digital certificate certifying a cryptographic key for a first entity implementing one or more network functions of a core network of a mobile communication system;

wherein the request indicates one or more purposes for which the digital certificate certifies the cryptographic key; and receive a digital certificate including an indication of the one or more purposes.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows an example mobile communication system to which some example embodiments may be applied;

FIG. 2 shows a representation of an example of operations of some elements of FIG. 1 according to some example embodiments;

FIG. 3 shows a representation of an example of operations of some elements of FIG. 1 according to some example embodiments;

FIG. 4 shows a representation of an example of operations of some elements of FIG. 1 according to some example embodiments;

FIG. 5 shows a representation of an example of operations of some elements of FIG. 1 according to some example embodiments;

FIG. 6 shows a representation of an example of operations of some elements of FIG. 1 according to some example embodiments;

FIG. 7 shows a representation of an example of operations of some elements of FIG. 1 according to some example embodiments;

FIG. 8 shows a representation of an example of apparatus for implementing core network functionality according to some example embodiments; and

FIG. 9 shows a representation of an example of non-volatile memory media.

### DETAILED DESCRIPTION

By way of example, the following description focusses on the example of a mobile communications system operating according to 3GPP 5G technology, but the underlying technique may also be applicable to systems operating according to other technologies, such as more evolved 3GPP technologies.

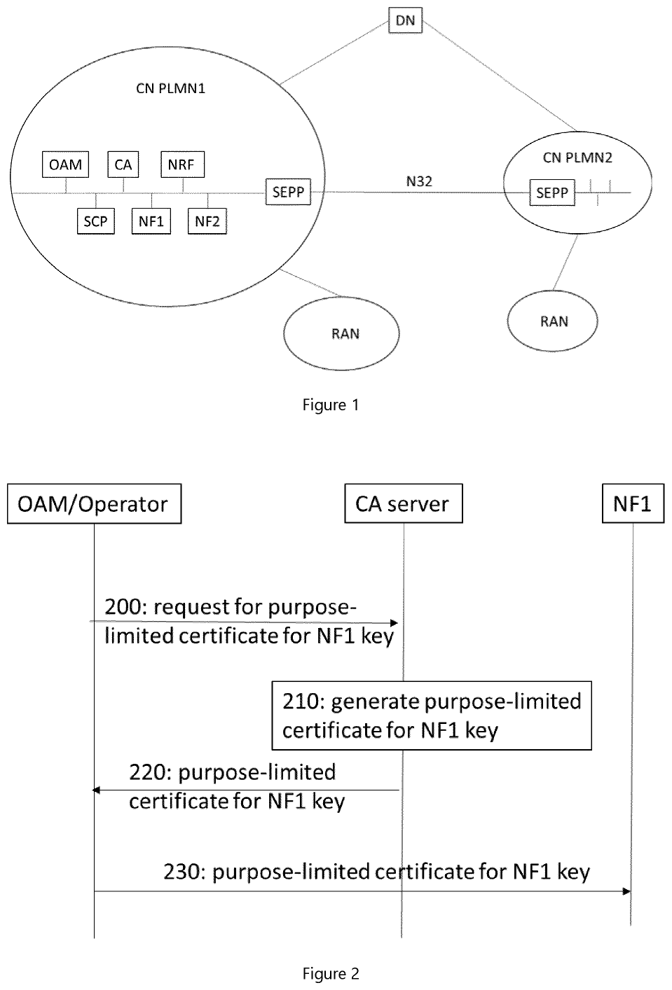

FIG. 1 shows a simple representation of one example of a 3GPP 5G system architecture. All the units shown in FIG. 1 are logical units. The connections shown in FIG. 1 are logical connections; the actual physical connections may be different. A 5G system may comprise other functions and structures than those shown in FIG. 1.

A core network may provide connections between devices implementing user equipment functionality (UEs) and one or more data networks (DN) via a New Generation Radio Access Network (NG-RAN) comprising a network of devices implementing instances of gNodeB (gNB) functionality.

A gNB is (i) connected to a user plane function (UPF) of the core network (CN), for routing and forwarding user data packets and for providing connectivity of devices to one or more external packet data networks (DN), and (ii) is connected to an access mobility management function (AMF) of the core network (CN) for controlling access and changes of serving cells for UEs.

The term “user equipment” (UE) may refer to any device, apparatus or component implementing at least 3GPP user equipment (UE) functionality.

The UE may be a mobile or static device (e.g. a portable or non-portable computing device) including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a UE device may also be a nearly exclusive uplink only device, of which an example is a camera or video camera loading images or video clips to a network. A UE device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a UE device may comprise a user portable device with radio parts (such as a watch, earphones or eyeglasses) and the computation is carried out in the cloud.

5G enables using multiple input—multiple output (MIMO) antennas, and may involve large numbers of base stations (gNBs) including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G may employ multiple frequency bands, e.g. below 6 GHz or above 24 GHZ, cmWave and mmWave, and may also be integrable with existing legacy radio access technologies, such as Long Term Evolution (LTE). Integration with LTE may be implemented, as a system, where macro coverage is provided by LTE and 5G radio interface access comes from small cells by aggregation to the LTE. In other words, 5G may support both inter-RAT operability (such as LTE-5G) and inter-RI operability (inter-radio interface operability, such as below 6 GHz—cmWave, 6 or above 24 GHz—cmWave and mmWave). 5G networks may employ network slicing, in which multiple independent and dedicated virtual sub-networks (network instances) may be created within the same infrastructure to run services that have different requirements on latency, reliability, throughput and mobility.

Low latency applications and services may be facilitated by bringing content close to the 5G system, which leads to local break out and multi-access edge computing (MEC). 5G enables analytics and knowledge generation to occur at the source of the data. This approach may involve leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The 5GC adopts a service-based architecture (SBA) according to which communication between network functions (implemented at core network entities) uses Service Based Interfaces (SBIs). Application Programming Interfaces (APIs) are used for the SBIs. Examples of network functions specified by 3GPP include: SCP (Service Communication Proxy); Network Repository Function (NRF); Operations Administration and Maintenance (OAM); Certificate Authority (CA); and Security Edge Protection Proxy (SEPP). NF1 and NF2 in FIG. 1 may be any network functions implemented by core network entities. The use of SBA for the core network is accompanied by protection at transport and application layers for interactions between core network entities. For example, Transport Layer Security (TLS 1.2 and 1.3) protocols may protect communication between core network entities at the transport layer; and the OAuth 2.0 framework may protect communications between core network entities at the application layer.

These security protocols may involve the use of a cryptographic public key (of a private-public key pair) for an entity implementing one or more network functions.

For example, TLS uses asymmetric cryptography (involving the use of at least one public key for at least one of the interacting core network entities) for securely generating and exchanging a session key, The session key is then used for encrypting and decrypting data transmitted between the interacting core network entities.

A digital certificate issued by a Certificate Authority (CA) may assert the authenticity of a public key.

The public key for a core network entity implementing one or more network functions may also be used e.g. in the verification at a receiving core network entity of a digital signature for an OAuth token that protects communications between core network entities at the application layer, and e.g. in securing messages sent by an entity of one core network (for one Public Land Mobile Network (PLMN)) to an entity of another core network (for another PLMN) via entities implementing security edge protection proxy (SEPP) function.

An application layer security solution on the N32 interface provides protection for communications between the SEPPs of respective core networks.

FIG. 2 illustrates an example of operations at elements of FIG. 1 according to some example embodiments.

A core network entity implementing OAM for the operator of PLMN1 sends to the CA server for the core network a request for a digital certificate for a public key for the end entity implementing NF1 (OPERATION 200). The request specifies one or more purposes for which the NF1 key is to be certified.

In response to the request, the CA server generates a digital certificate for the NF1 key (OPERATION 210). The certificate indicates the one or more purposes specified in the request from OAM.

The CA server sends the digital certificate issued by the CA server to the core network entity implementing OAM (OPERATION 220).

The core network entity implementing OAM sends the digital certificate to the core network end entity (EE) implementing NF1 (OPERATION 230).

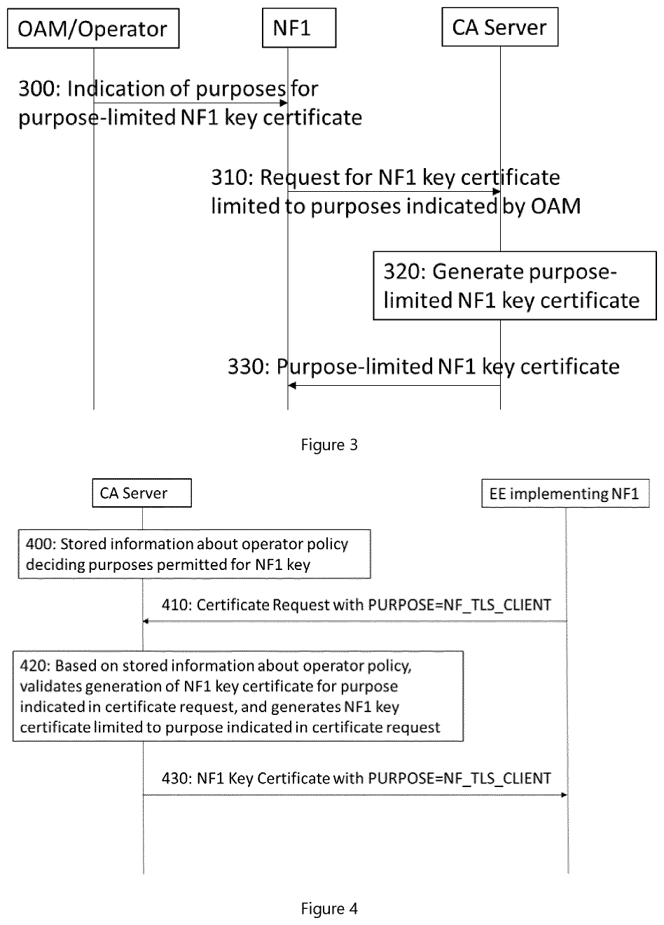

FIG. 3 illustrates another example of operations at elements of FIG. 1 according to some example embodiments.

A core network entity implementing OAM for the operator of PLMN1 sends to the EE implementing NF1 an indication of one or more purposes for which the operator policy permits use of a public key for NF1 (OPERATION 300).

NF1 sends to the CA server a request for a digital certificate for a public key for NF1 (OPERATION 310). The request to the CA server indicates the purposes indicated in the message from OAM to NF1.

CA server generates a digital certificate for the public key for NF1 (OPERATION 320). The digital certificate issued by the CA server for the public key for NF1 includes an indication of the one or more purposes indicated in the request from NF1.

CA server sends the digital certificate to NF1 (OPERATION 330).

FIG. 4 illustrates an example of operations at elements of FIG. 1 according to some example embodiments. FIG. 4 relates to an example of an operator policy according to which a public key for an example network function NF1 is limited to use in creating a TLS connection with another core network entity.

CA server stores information about operator policy relating to the use of public keys by entities of the core network, including the EE implementing NF1 (OPERATION 400).

The EE implementing NF1 sends to CA server a request for a digital certificate for a public key for NF1 (OPERATION 410). The request from NF1 specifies that the public key is to be used for the purpose of establishing a TLS connection between NF1 (as client) with another core network entity (acting as server).

Based on the information stored at CA server about operator policy, CA server determines that operator policy permits the issue of a public key certificate for NF1 for the indicated purpose, and generates a digital certificate including an indication that the digital certificate certifies the public key for the indicated purpose (OPERATION 420).

CA server sends the issued digital certificate to NF1 (OPERATION 430).

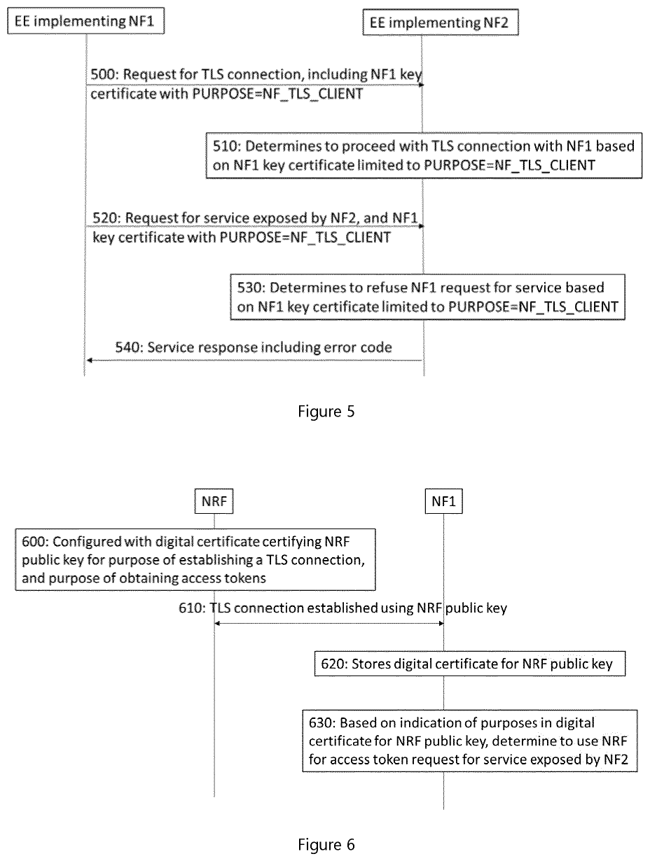

FIG. 5 illustrates an example of subsequent operations at NF1 and another example network function NF2, according to some example embodiments.

NF1 sends to NF2 a request for a TLS connection with NF2 (OPERATION 500). The request includes the digital certificate issued by CA server for the public key for NF1.

NF2 reads the indication of purposes included in the digital certificate, and determines that the digital certificate does certify the NF1 public key for the purpose of establishing a TLS connection (OPERATION 510).

Using the TLS connection established with NF2, NF1 sends to NF2 a request for a service exposed by NF2 (OPERATION 520). The request includes the digital certificate issued by the CA server for the public key for NF1. The request also includes a client credential assertion (CCA).

NF2 again reads the indication of purposes in the digital certificate. NF2 determines that the digital certificate does not certify the NF1 public key for the purpose of verifying CCA. Accordingly, NF2 determines to refuse the service request from NF1 (OPERATION 530).

NF2 sends to NF1 a service response including an error code.

FIG. 6 illustrates another example of operations at elements of FIG. 1 according to some example embodiments.

An entity implementing NRF for the core network is configured with a digital certificate certifying a public key for NRF for two purposes: (i) establishing a TLS connection with another core network entity; and (ii) access token signing (OPERATION 600).

NRF uses the NRF public key to establish a TLS connection with NF1 (OPERATION 610).

NF1 stores the digital certificate for the NRF public key (OPERATION 620).

NF1 determines to consume a service exposed by another network function NF2 discovered via NRF. Based on the indication of purposes in the digital certificate for the public key for NRF, NF1 determines to obtain, from NRF, an access token necessary to consume the service exposed by NF2 (OPERATION 640).

In the example of FIG. 6, the producer network function (NFp) belongs to the same core network (same PLMN) as the consumer network function (NFC). In an alternative example in which NFc and NFp belong to different core networks (different PLMNs), two NRF functions may be involved: a NRFc belonging to the same core network as NFc and via which NFc discovers NFp; and a NRFp that belongs to the same core network as NFp, and which may sign the access token for request service from NFp. In this alternative example, NRFc checks the digital certificate for the public key for NRFp, and only requests an access token from NRFp for requesting service from NFp if the digital certificate certifies the public key for NRFp for the purpose of access tokens signing.

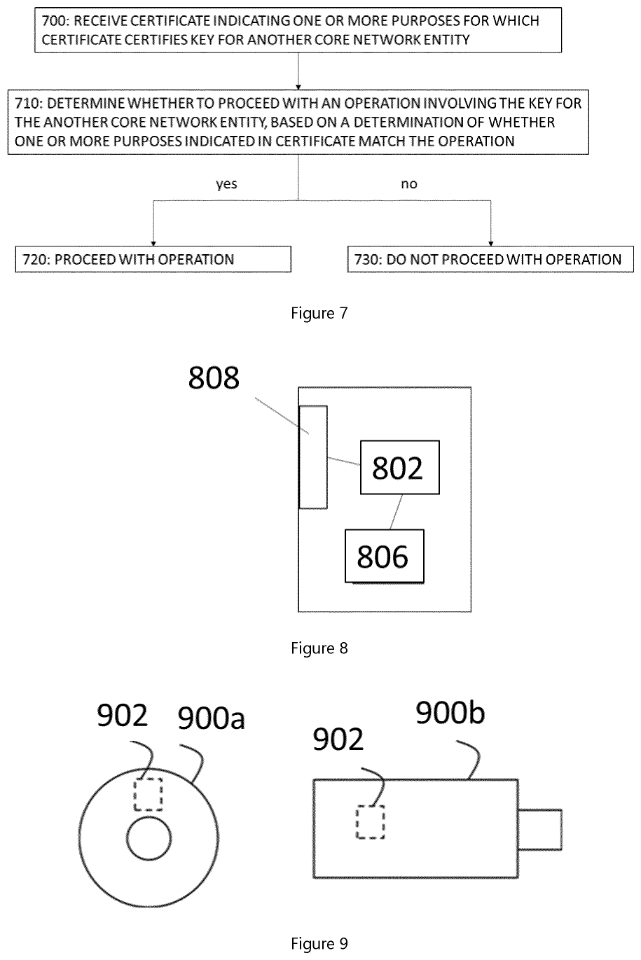

FIG. 7 illustrates an example of operations at a core network entity, according to some example embodiments.

The core network entity receives a digital certificate for the public key for another core network entity (STEP 700). The digital certificate includes an indication of the purposes for which the certificate certifies the public key of the another core network entity.

The receiving core network entity determines whether to proceed with an operation involving the public key of the another core network entity, based at least partly on the indication of purposes included in the digital certificate (STEP 710). The operation involving a public key of the another core network entity may, for example, be: establishing a TLS connection with the another core network entity; securing access tokens by means of a digital signature verifiable by the public key; securing o-auth tokens by means of a digital signature verifiable by the public key.

In response to a positive determination, the receiving core network entity proceeds with the operation (STEP 720). In response to a negative determination, the receiving core network entity does not proceed with the operation (STEP 730).

The above-described examples refer to general network functions NF1 and NF2. The network function receiving and checking the purpose indication in the digital certificate for the public key, and/or the network function to which the public key belongs, may be specific functions defined by 3GPP, such as e.g. SCP or SEPP.

The above techniques may, for example, involve enhancement of a digital certificate conforming to ITU-T X.509 standard for public key infrastructures and having a structure defined by RFC5280.

According to one example, the enhancement comprises defining new purpose IDs for the existing extendedKeyUsage field of the X.509 digital certificate structure. Examples of new purpose IDs are set out below.

| | |
|---|---|
| id-kp-CCASigning | OBJECT IDENTIFIER ::= { id-kp 10 } |

```
  -- Signing CCA tokens
  -- Key usage bits that may be consistent: digitalSignature
  -- and/or nonrepudiation
```

| | |
|---|---|
| id-kp-OATUHSigning | OBJECT IDENTIFIER ::= { id-kp 11 } |

```
  -- Signing o-auth access tokens
  -- Key usage bits that may be consistent: digitalSignature
  -- and/or nonrepudiation
```

| | |
|---|---|
| id-kp-SEPPDataEncryption | OBJECT IDENTIFIER ::= { id-kp 12 } |

```
  -- Encrypting SEPP messages
  -- Key usage bits that may be consistent: digitalSignature
  -- and/or nonRepudiation
```

Additionally or alternatively, the free text of the existing subjectAltName (SAN) field of the X.509 digital certificate structure is used to indicate the one or more purposes for which the certificate certifies the NF public key. According to one example, the CA server adds to the SAN field an indication of the purposes specified in the certificate request (CSR/IR) from the NF using an automatic enrolment protocol such as CMPv2. According to another example, the operator can manually fetch the certificate already containing the purpose indication(s) in the SAN field.

According to one example, the SAN field may be enhanced to contain a purpose string. One example is set out below.

<PURPOSE-LIST>NF_TLS_CLIENT, NF_TLS_SERVER,
ACCESSTOKEN_SIGNING,CCA_SIGNING</PURPOSE-LIST>

According to one example, the SAN field contains the above defined PURPOSE-LIST in the URI (uniform resource identifier) as a URN (Uniform Resource Name).;

According to another example, the one or more purposes for which the certificate certifies the NF public key are indicated in another existing field of the X.509 digital certificate structure, or are indicated in a new field dedicated to identifying the one or more purposes for which the certificate certifies the NF public key.

The above-described techniques can help to prevent violations of CA policies, and can help to reduce the risk of cross-protocol attacks. The above-described techniques can help to prevent a NF from obtaining a certificate which can be misused for tasks that the NF is not entitled to perform. For example, the above-described techniques may help to prevent a consumer function impersonating a producer function using their own client certificate.”

FIG. 8 illustrates an example of an apparatus for implementing any of the core network functions in FIG. 1. The apparatus may include at least one processor 802 coupled to one or more interfaces 808 for e.g. communication with one or more entities implementing other core network functions. The at least one processor 802 may also be coupled to at least one memory 806. The at least one processor 802 may be configured to execute an appropriate software code to perform the operations described above. The software code may be stored in the memory 806.

FIG. 9 shows a schematic representation of non-volatile memory media 900a (e.g. computer disc (CD) or digital versatile disc (DVD)) and 900b (e.g. universal serial bus (USB) memory stick) storing instructions and/or parameters 902 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described example embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The features, advantages, and characteristics described herein can be combined in any suitable manner in one or more example embodiments. One skilled in the relevant art will recognize that such example embodiments can be practiced without one or more of the specific features or advantages of a particular embodiment. In other instances, additional features and advantages can be recognized in certain embodiments that may not be present in all example embodiments. One having ordinary skill in the art will readily understand that the example embodiments as discussed above may be practiced with steps in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-70. (canceled)

71. A first entity implementing at least a first network function of a core network for a mobile communication system, the first entity comprising: at least one processor; and at least one memory including computer program code, the at least one memory and computer program code configured to, with the at least one processor, cause the first entity to perform:
receiving a digital certificate certifying a cryptographic key for the first entity: wherein the digital certificate indicates one or more purposes for which the digital certificate certifies the cryptographic key; and
sending the digital certificate to a second entity implementing at least a second network function of the core network for the mobile communication system.

72. The first entity according to claim 71, wherein the one or more purposes comprise one or more of: establishing a secure logical connection between the first and second entities; or verifying client credential assertion tokens; or verifying access tokens: or verifying service request.

73. The first entity according to claim 71, wherein the digital certificate conforms to ITU-T X.509 standard for public key infrastructures.

74. The first entity according to claim 71, wherein the digital certificate includes a field populated by one or more identifier values indicating the one or more purposes.

75. The first entity according to claim 71, wherein the digital certificate includes a field supporting free text, and the field includes free text indicating the one or more purposes.

76. The first entity according to claim 75, wherein the field supporting free text also indicates a subject name.

77. The first entity according to claim 71, wherein sending the digital certificate to the second entity is at least for establishing a secure connection between the first and second entities using at least the cryptographic key of the first entity; and wherein the one or more purposes comprise establishing a secure connection between first and second entities.

78. The first entity according to claim 77, wherein the at least one memory and computer program code are further configured to, with the at least one processor, cause the first entity to request via the secure logical connection between the first and second entities a service exposed by the second entity.

79. The first entity according to claim 78, wherein requesting the service comprises sending a digital signature for a token to access the service, wherein the digital signature is verifiable at the second entity using the cryptographic key of the first entity.

80. The first entity according to claim 71, wherein the at least one memory and computer program code are further configured to, with the at least one processor, cause the first entity to request the digital certificate from a certificate authority.

81. A second entity implementing at least a second network function of a core network for a mobile communication system, the second entity comprising: at least one processor; and at least one memory including computer program code, the at least one memory and computer program code configured to, with the at least one processor, cause the second entity to perform:
receiving, from a first entity implementing at least a first network function of the core network for the mobile communication system, a digital certificate including an indication of one or more purposes for which the digital certificate certifies a cryptographic key for the first entity; and
based at least partly on the indication of the one or more purposes, determining at the second entity whether to proceed with one or more operations involving the cryptographic key of the first entity.

82. The second entity according to claim 81, wherein the at least one memory and computer program code are further configured to, with the at least one processor, cause the second entity to: based at least partly on the indication of the one or more purposes, determine whether to establish a secure logical connection between the first and second entities using at least the cryptographic key of the first entity.

83. The second entity according to claim 82, wherein the at least one memory and computer program code are configured to, with the at least one processor, cause the second entity to: receive from the first entity a service request including a digital signature for a service access token, and based at least partly on the indication of the one or more purposes, determine whether the cryptographic key is certified for verifying the digital signature.

84. The second entity according to claim 81, wherein the at least one memory and computer program code are configured to, with the at least one processor, cause the second entity to: based at least partly on the indication of the one or more purposes, determine whether to request the first entity to request an access token on behalf of the second entity.

85. Apparatus comprising: at least one processor; and at least one memory including computer program code, the at least one memory and computer program code configured to, with the at least one processor, cause the apparatus to perform:
receiving a request to generate a digital certificate certifying a cryptographic key for a first entity implementing one or more network functions of a core network of a mobile communication system: wherein the request indicates one or more purposes for which the digital certificate certifies the cryptographic key; and
issuing a digital certificate including an indication of the one or more purposes.
